(19) United States
(12) Patent Application Publication
(10) Pub. No.: US 2025/0234368 A1
(43) Pub. Date: Jul. 17, 2025

(54) METHODS, APPARATUS, AND SYSTEM FOR COMMUNICATION-ASSISTED SENSING

(71) Applicant: Huawei Technologies Co., Ltd., Shenzhen (CN)

(72) Inventors: Alireza Bayesteh, Brossard (CA); Xiaoyan Bi, Shanghai (CN); Jianglei Ma, Ottawa (CA)

(21) Appl. No.: 19/040,376

(22) Filed: Jan. 29, 2025

Related U.S. Application Data
(63) Continuation of application No. PCT/CN2022/109306, filed on Jul. 30, 2022.

(51) Int. Cl. H04W 72/51; H04W 24/10; H04W 72/12

(52) U.S. Cl. CPC H04W 72/51; H04W 24/10; H04W 72/12

(57) ABSTRACT

Upon learning of a device's sensing capability, a network node may transmit, to the device, a sensing report configuration. The network node may transmit, to the device, a definition for a sensing region of a communication scheduling region. The network node may further transmit, to the device, a definition for a sensing feedback report channel. After transmitting, to the device, scheduled data transmissions, the network node may receive, from the device over the sensing feedback report channel, a sensing report based on processing those scheduled data transmissions that have been received, by the device, in the sensing region.

### CROSS-REFERENCE TO RELATED APPLICATION

This application is a continuation of International Application No. PCT/CN2022/109306, filed on Jul. 30, 2022, the disclosure of which is hereby incorporated by reference in its entirety.

### TECHNICAL FIELD

The present disclosure relates, generally, to sensing in wireless networks and, in particular embodiments, to communication-assisted sensing.

### BACKGROUND

Existing sensing schemes may be considered to be characterized either as mono-static sensing or as multi-static sensing.

In mono-static sensing schemes, a given network node transmits a radio frequency (RF) sensing signal. The given network node also receives echoes of the RF sensing signal. Conveniently, for this configuration, there is no need for the extra overhead that is known to be related to the use of pilot signals, as communication data may be reused for sensing signals. However, it may be considered that mono-static sensing schemes rely upon full duplex capability or a special signal design for sensing reception. In addition, the scope of the sensing may be considered to be limited to an area surrounding the given network node.

In multi-static sensing, a node that receives echoes of a sensing signal is distinct from a node that transmits the sensing signal. An example of multi-static sensing is so-called bi-static sensing, wherein a transmitting node transmits a sensing signal and a receiving node receives the sensing signal after the sensing signal has traversed the channel between the transmitting node and the receiving node. The use of multi-static sensing may be shown to enable efficient and scalable environment sensing through collaborative sensing.

### SUMMARY

Exploiting advantages of multi-static sensing for future wireless communication networks will encounter numerous challenges. In a multi-static sensing approach based on using dedicated sensing pilot signals, the disadvantage lies in the amount of overhead caused by the dedicated sensing pilot signals. Alternatively, in an approach based on reusing communication pilot signals as sensing pilot signals, the communication pilots may be considered to be too sparse to achieve a processing gain that provides suitable sensing performance.

Aspects of the present application relate to schemes for implementing multi-static sensing schemes in ways that aim to avoid the disadvantages of the existing proposed schemes outlined above.

Aspects of the present application relate to using communication data as a sensing pilot signal. One advantage of using communication data as a sensing pilot signal is a reduction in sensing overhead. Another advantage of using communication data as a sensing pilot signal is a processing gain. The processing gain may be attributed to a large number of data symbols. The large number of data symbols may be shown to enable relatively simple Fast Fourier Transform (FFT)-based reception. Another advantage of using communication data as a sensing pilot signal is that the communication data may be considered to resemble a large-size set of random data. Using a large-size set of random data for sensing pilot signals may be shown to have advantages in terms of auto-ambiguity. A degree of auto-ambiguity is known to be a key performance indicator as far as delay estimation and Doppler shift estimation are concerned.

Aspects of the present application relate to various communication-assisted sensing schemes in which a user equipment may use communication signals for sensing purposes.

Upon learning of a device's sensing capability, a network node may transmit, to the device, a sensing report configuration. The network node may transmit, to the device, a definition for a sensing region of a communication scheduling region. The network node may further transmit, to the device, a definition for a sensing feedback report channel. After transmitting, to the device, scheduled data transmissions, the network node may receive, from the device over the sensing feedback report channel, a sensing report based on processing those scheduled data transmissions that have been received, by the device, in the sensing region.

The existing versions of multi-static sensing solutions do not provide an end-to-end solution to address the overhead issues and performance issues inherent in the existing versions of multi-static sensing solutions.

Aspects of the present application relate to a multi-static sensing solution that features a sensing performance that may be optimized based on sensing capabilities of a node that is expected to carry out the sensing. By processing scheduled data transmissions to obtain sensing parameters, efficient sensing is enabled. The sensing may be considered to be efficient based on avoiding use of additional sensing overhead. Sensing performance enhancement (due, in part, to increased processing gain) and resolution enhancement may be considered to be possible due to a large number of data symbols in the scheduled data transmissions. The large number of data symbols may be seen to enable very simple sensing reception algorithms (e.g., FFT-based schemes) without needing sophisticated algorithms (e.g., super resolution schemes).

Aspects of the present application relate to a configuration for an efficient sensing feedback report. That is, the sensing feedback report may gain efficiency by relating to a plurality of data blocks.

Aspects of the present application relate to decoding and processing, for sensing purposes, scheduled data transmissions on a plurality of beams. Conveniently, a power saving may be achieved, as power need not be spent on beamforming for a sensing signal, because beamforming is already known through communication establishment.

According to an aspect of the present disclosure, there is provided a method for a network node or base station. The method includes receiving, from a device, a sensing capability report. The method further includes transmitting, to the device, a definition for a sensing region, the sensing region definition defined based on the sensing capability report. The method further includes transmitting, to the device, a definition for a sensing feedback report channel, and transmitting, to the device, a data transmission. The method further includes receiving, from the device over the sensing feedback report channel, a sensing report based on processing the scheduled data transmissions received in the sensing region.

According to another aspect of the present disclosure, there is provided a method for an electronic device or User Equipment. The method includes transmitting a sensing capability report to a base station. The method further includes receiving a definition for a sensing region from the base station, the sensing region definition defined based on the sensing capability report. The method further includes receiving a definition for a sensing feedback report channel from the base station, and receiving a data transmission from the base station. The method further includes transmitting, over the sensing feedback report channel to the base station, a sensing report based on processing the data transmission received in the sensing region.

Further aspects of the present disclosure relate to apparatuses, computer-readable storage mediums, computer program product, and processors for performing the preceding methods.

According to another aspect of the present disclosure, there is provided a system comprising a device and a base station in wireless communication with the device. The device is configured to transmit a sensing capability report and receive a data transmission. The device is further configured to transmit, over a sensing feedback report channel, a sensing report based on processing the data transmission received in a sensing region. The base station is configured to transmit, to the device, a definition for the sensing region based on the sensing capability report. The base station is further configured to transmit, to the device, a definition for the sensing feedback report channel based on the sensing capability report. The base station is further configured to transmit, to the device, the data transmission.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates an example communication scheduling region;

FIG. 7 illustrates, in a signal flow diagram, an example of signal flow between an electronic device and a transmit receive point, in accordance with aspects of the present application;

FIG. 8 illustrates a sensing region indicated as a subset of the example communication scheduling region of FIG. 6, in accordance with aspects of the present application;

FIG. 9 illustrates example steps in a method of processing received scheduled transmissions for carrying out by an electronic device with no buffering capability and no multi-bandwidth part processing capability, in accordance with aspects of the present application;

FIG. 10 illustrates example steps in a method of processing received scheduled transmissions for carrying out by an electronic device with buffering capability and with multi-bandwidth part processing capability, in accordance with aspects of the present application;

FIG. 11 illustrates a diagram of time-frequency resources including a physical downlink control channel that includes an instruction for the electronic device, in accordance with aspects of the present application;

FIG. 12 illustrates a table wherein a quantity of bits is associated with each field in a plurality of fields of downlink control information in the physical downlink control channel of FIG. 11, in accordance with aspects of the present application;

FIG. 13 illustrates a diagram of time-frequency resources including a physical downlink control channel that includes an instruction for the electronic device, in accordance with aspects of the present application;

FIG. 14 illustrates a table wherein a quantity of bits is associated with each field in a plurality of fields of downlink control information in the physical downlink control channel of FIG. 13, in accordance with aspects of the present application;

FIG. 15 illustrates a diagram of time-frequency resources including a sensing feedback report corresponding to NACK data blocks in a manner that is separate from a sensing feedback report corresponding to ACK data blocks, in accordance with aspects of the present application;

FIG. 16 illustrates a diagram of time-frequency resources including a sensing feedback report corresponding to NACK data blocks and ACK data blocks in a single report opportunity, in accordance with aspects of the present application; and

FIG. 17 illustrates a first communication scheduling region for a first set of physical downlink shared channel transmissions and a second communication scheduling region for a second set of physical downlink shared channel transmissions.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

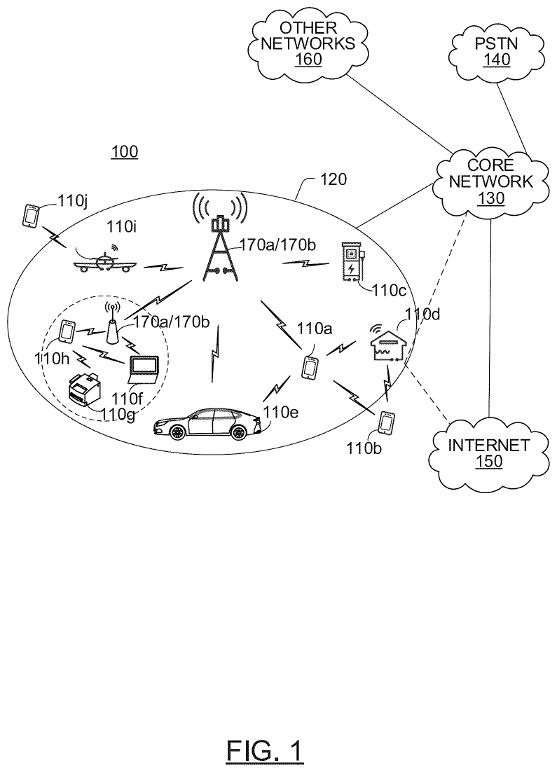

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

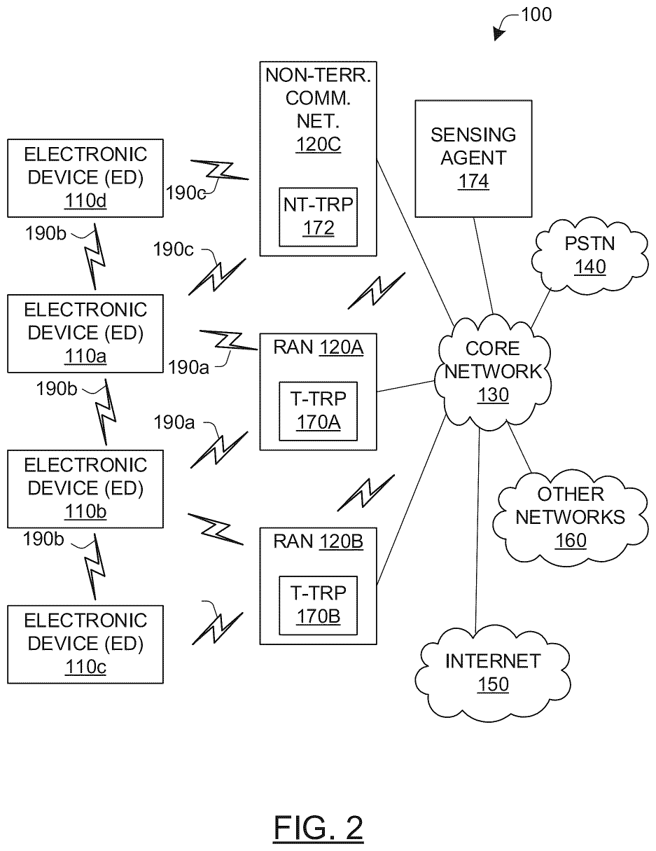

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

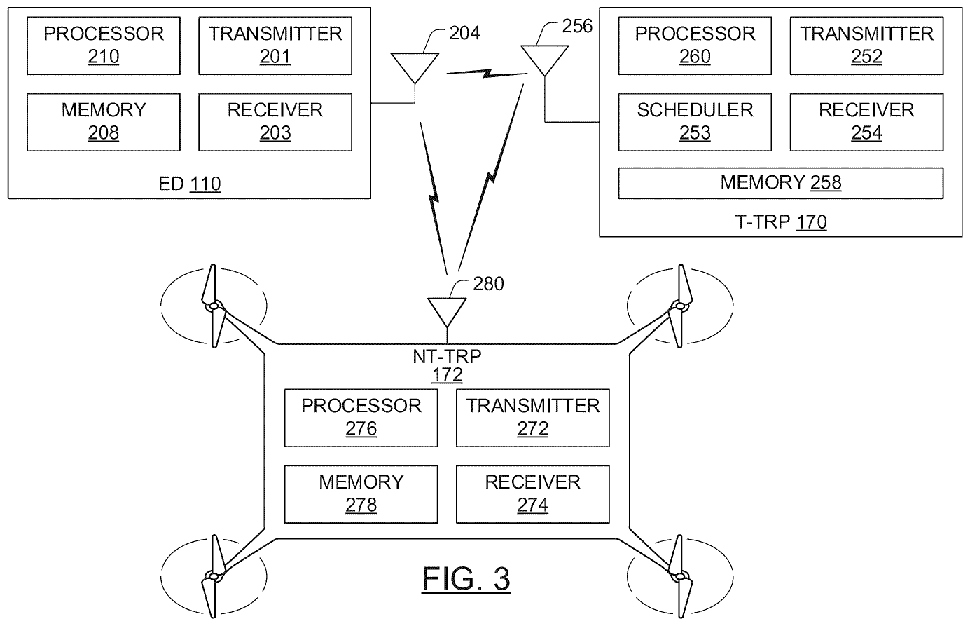

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

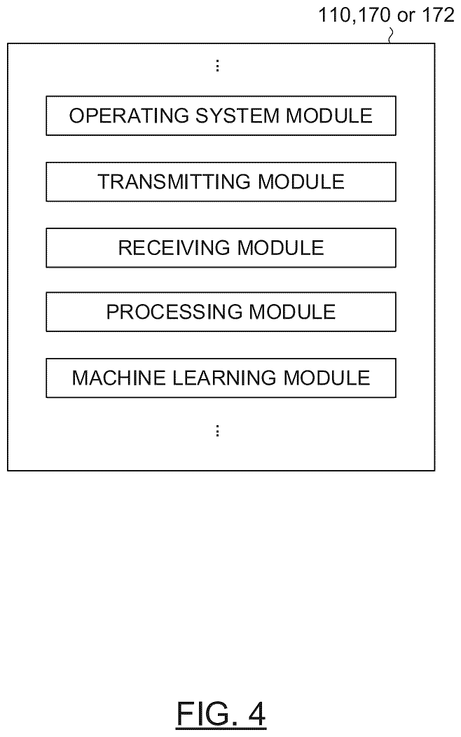

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

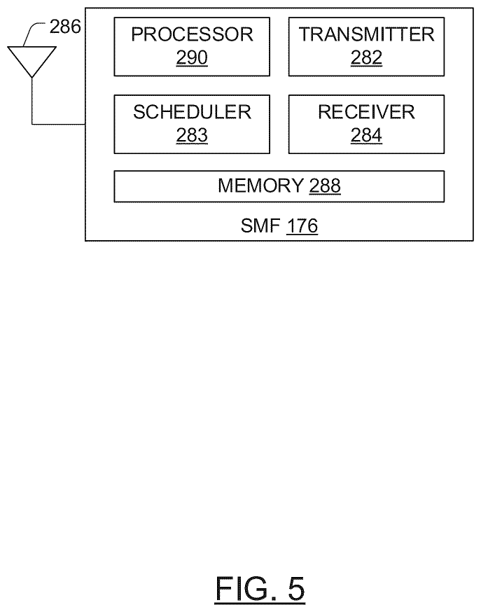

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}-t_{chirp0}. Such linear chirp signal can be presented as e^{jπαt}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas is arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or an SSB resource identifier, or a sounding reference signal (SRS) resource identifier, or other reference signal resource identifier.

Given a choice between mono-static sensing and multi-static sensing, it may be considered that, to realize a “network-as-a-sensor” concept in future wireless communication systems, a multi-static sensing configuration is the most appropriate selection. Some existing proposals may be understood to try to exploit advantages of multi-static sensing for future wireless communication networks. One of the existing proposals is a scheme that is based on using dedicated sensing pilot signals. Another of the existing proposals is a scheme that is based on reusing communication pilot signals as sensing pilot signals. Example communication pilot signals include CSI-RS, demodulation reference signals (DMRS), phase tracking reference signals (PTRS) and positioning reference signals (PRS). A scheme based on using dedicated sensing pilot signals may be considered to have a disadvantageous amount of overhead. In a scheme based on reusing communication pilots, the communication pilots may be considered to be too sparse to achieve a processing gain that provides suitable sensing performance.

Aspects of the present application relate to schemes for implementing multi-static sensing schemes in ways that aim to avoid the disadvantages of the existing proposed schemes, which disadvantages have been outlined hereinbefore.

Aspects of the present application relate to using communication data as a sensing pilot signal. One advantage of using communication data as a sensing pilot signal is a reduction in sensing overhead. Another advantage of using communication data as a sensing pilot signal is a processing gain. The processing gain may be attributed to a large number of data symbols. The large number of data symbols may be shown to enable relatively simple Fast Fourier Transform (FFT)-based reception. Another advantage of using communication data as a sensing pilot signal is that the communication data may be considered to resemble a large-size set of random data. Using a large-size set of random data for sensing pilot signals may be shown to have advantages in terms of auto-ambiguity. A degree of auto-ambiguity is known to be a key performance indicator as far as delay estimation and Doppler shift estimation are concerned.

Aspects of the present application relate to various communication-assisted sensing schemes in which a user equipment may use communication signals for sensing purposes.

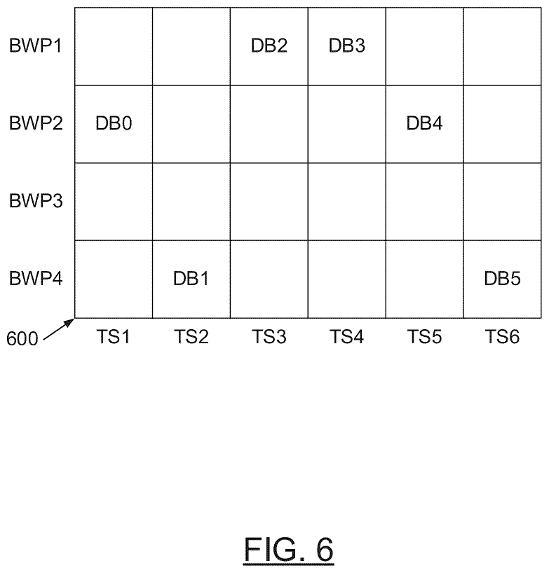

FIG. 6 illustrates an example communication scheduling region 600. The example communication scheduling region 600 is defined as a grid indexed by bandwidth part (BWP1, BWP2, BWP3, BWP4) and by time slot (TS1, TS2, TS3, TS4, TS5, TS6). Notably, a generic communication scheduling region may be defined as being indexed by K bandwidth parts, where K does not necessarily equal four. Similarly, a generic communication scheduling region may be defined as being indexed by M time slots, where M does not necessarily equal six. The example communication scheduling region 600 of FIG. 6 includes six data block transmissions (DB0, DB1, DB2, DB3, DB4, DB5).

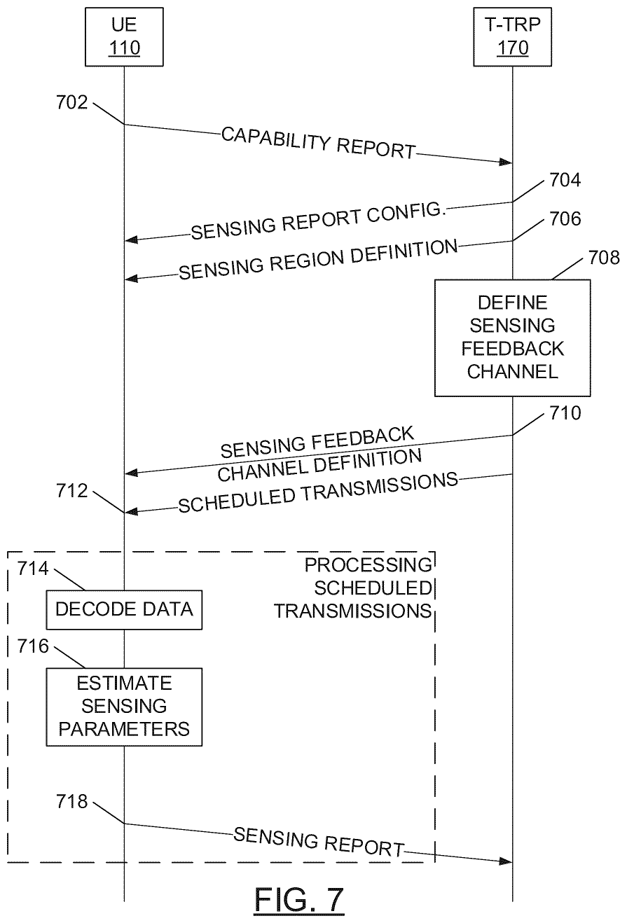

FIG. 7 illustrates, in a signal flow diagram, an example of signal flow between a UE 110 and a TRP 170. Initially, the UE 110 may transmit (step 702), to the TRP 170, a capability report. The capability report may include an indication of a buffering capability at the UE 110 and an indication of a sensing processing capability at the UE 110. The indication of the sensing processing capability may include one or more of: an indication of a sensing processing delay; an indication of a sensing bandwidth processing capability; and an indication of a sensing time duration processing capability.

Responsive to receiving the capability report, the TRP 170 may transmit (step 704), to the UE 110, a sensing report configuration. The TRP 170 may, for example, use RRC signaling to transmit (step 704) the sensing report configuration. The UE 110 may use the sensing report configuration to define the contents of its sensing report and/or the manner in which the sensing report is transmitted, as described further below. For example, the sensing report configuration may define how the UE 110 is to behave in case of decoding errors, and whether the sensing report is to be merged with feedback of the decoding error or separately transmitted.

The TRP 170 may next transmit (step 706) information defining a sensing region. The TRP 170 may, for example, use the DCI to transmit (step 706) the sensing region definition. Notably, the sensing region may be defined to include the entirety of a given communication scheduling region (see the example communication scheduling region 600 of FIG. 6) or a subset of the given communication scheduling region. The sensing region definition may be based on the capability report transmitted (step 702) by the UE 110. The sensing region definition may additionally or alternatively be based on a specified “quality of sensing” (QoSe) parameter. The communication scheduling region may include a number, N, of data block transmissions that are allocated for sensing detection.

The TRP 170 may define (step 708) a sensing feedback channel.

When defining (step 708) the sensing feedback channel, the TRP 170 may take into account a length dimension of the sensing region, self-reported UE processing latency, a sensing report type and an acceptable sensing latency parameter.

The TRP 170 may then transmit (step 710), to the UE 110, an indication of the definition of the sensing feedback channel.

The transmission (step 710) of the definition of the sensing feedback channel may be accomplished using DCI.

Responsive to receiving (step 712) scheduled transmissions from the TRP 170, the UE 110 may process the received scheduled transmissions. The processing of the received scheduled transmissions may include performing (step 714) data decoding of the scheduled transmissions to, thereby, obtain decoded data. The UE 110 may buffer the decoded data. The processing of the received scheduled transmissions may include the UE 110 performing (step 716) a sensing parameter estimation operation. The UE 110 may base the performing (step 716) of the sensing parameter estimation operation on the knowledge of the already decoded data of the data block transmissions that are allocated for sensing detection.

The processing of the received scheduled transmissions may further include the UE 110 transmitting (step 718), to the TRP 170, a sensing report. The UE 110 may employ the sensing feedback channel as described in the received definition. The UE 110 may use the PUSCH to transmit (step 718) the sensing report.

The sensing report may be merged with and transmitted with other information or sent alone. For one example, the other information may be communication-related feedback, in which case, the sensing report may be merged with communication-related feedback and the merged information may be transmitted on a communication-related feedback channel. When the sensing report is to be sent alone, the sensing report may be transmitted on a dedicated sensing report channel. The merging of the sensing report with the other information may depend on a timing relation between the sensing report and the other information.

The UE capability report transmitted in step 702 may include an indication of a capability for buffering data after decoding (step 714) the scheduled transmissions that have been received (step 712) at the UE 110. In a first scenario, the UE 110 does not have a capability to buffer the data blocks that have been received (step 712) and decoded (step 714). In this first scenario, the UE 110 may be configured to perform (step 716) the sensing parameter estimation operation on each individual decoded data block responsive to the data block having been decoded (step 714). In a second scenario, the UE 110 has a capability to buffer the data blocks that have been received (step 712) and decoded (step 714). Indeed, the UE 110 may have a capability to buffer a plurality of decoded data blocks. The UE 110 may be configured to perform (step 716) the sensing parameter estimation operation over the plurality of decoded data blocks.

The UE capability report transmitted in step 702 may include an indication of a capability for carrying out multi-BWP and parallel baseband sensing parameter estimation after the data blocks have been decoded (step 714). In a first scenario, the UE 110 does not have a capability to perform (step 716) sensing parameter estimation over multiple BWPs. Accordingly, the UE 110 may be configured to perform (step 716) sensing parameter estimation on the data blocks decoded from a particular BWP. In a second scenario, the UE 110 has a capability to perform (step 716) sensing parameter estimation on the data blocks that have been decoded (step 714) over multiple BWPs jointly.

The UE capability report transmitted in step 702 may include an indication of a processing capability. The indication of processing capability may include an indication of a sensing bandwidth processing capability. The indication of processing capability may also include an indication of a time processing capability. The indication of processing capability may further include an indication of how complex the sensing reception can be. The indication of how complex the sensing reception can be may be expressed in terms of the FFT size the receiver can handle and whether the receiver can employ super-resolution algorithms. The UE capability report, transmitted in step 702, may include an indication of a UE power mode. The indication of the sensing processing delay may be understood to relate to how much power budget the UE has available for performing the sensing operation (after decoding its scheduled data blocks). The indication of the UE power mode may implicitly indicate other capabilities, such as processing capability, multi-BWP processing capability and receiver complexity capability.

The UE capability report transmitted in step 702 may include an indication of a sensing processing delay. The indication of the sensing processing delay may be understood to relate to a quantity of additional latency (time taken) that may be related to the UE 110 performing (step 716) sensing parameter estimation to obtain the sensing report. This delay is called “additional” latency due to latency already being associated with the time taken for the UE 110 to decode (step 714) received data blocks.

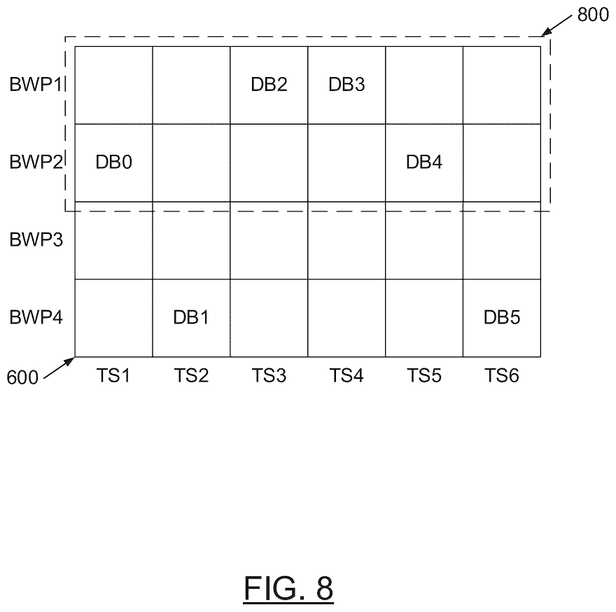

FIG. 8 illustrates a sensing region 800 indicated as a subset of the example communication scheduling region 600 of FIG. 6.

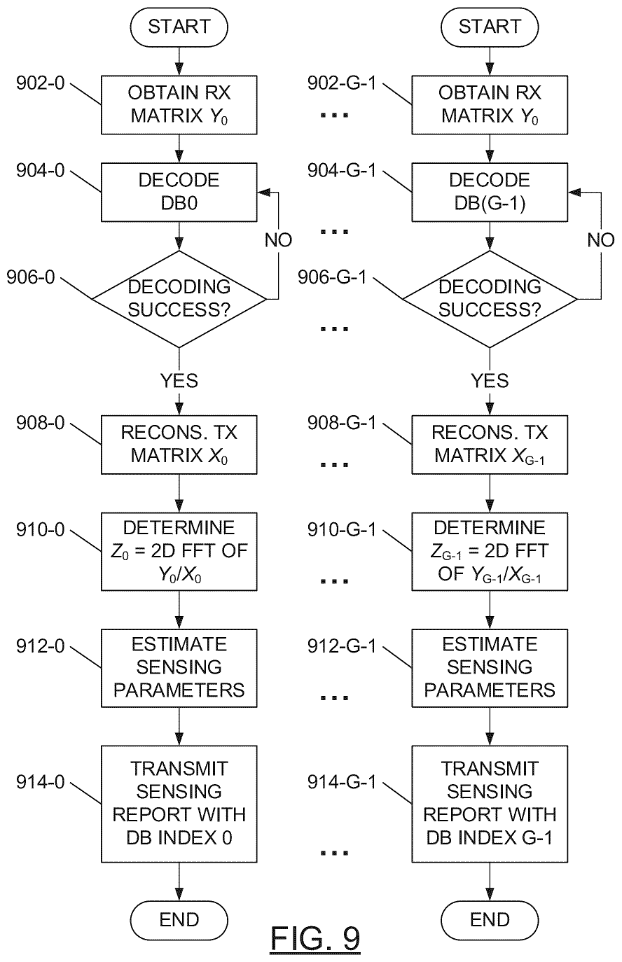

FIG. 9 illustrates example steps in a method of processing received scheduled transmissions for carrying out by a UE 110 with no buffering capability and no multi-BWP processing capability. Due to the lack of buffering capability and multi-BWP processing capability, the UE 110 may be configured to separately perform sensing parameter estimation on each decoded data block. The method of FIG. 9 is presented as a plurality of methods performed on a plurality of example data blocks. The example data blocks are referenced with data block indices DBO and DB(G−1). As illustrated in FIG. 8, it may be that not all data blocks are designated for sensing.

The plurality of methods illustrated in FIG. 9 are based on an assumption that the data block, DBo, in the first time slot is designated for sensing and that the data block, DB(G−1), in the G^{th} time slot is designated for sensing. Additionally, the plurality of methods illustrated in FIG. 9 are based on an assumption that an OFDM-based waveform is used for communication/sensing. The plurality of methods illustrated in FIG. 9 are based on an assumption that the UE 110 has no multi-BWP capability and therefore, the G DBs should be scheduled for the UE 110 over G time slots. This is not necessarily true in the general case. In the general case, multiple DBs can be scheduled for the UE 110 over the same time slot.

In the first time slot, the UE 110 obtains (step 902-0) a first reception matrix, Y₀. The first reception matrix, Y₀, may be understood to indicate the set of received complex symbols over each resource element (RE) after applying waveform demodulation through cyclic prefix removal and FFT operation on a received time domain signal, y(t). The UE 110 then decodes (step 904-0) the first data block, referenced with a data block index, DBo. Upon determining (step 906-0) that the decoding has been successful, the UE 110 reconstructs (step 908-0) the first transmission matrix, X₀. Reconstructing the first transmission matrix, X₀, involves applying forward error correction over the decoded information bits, modulating the coded bits and mapping the modulated symbols over the resource elements corresponding to the time/frequency region assigned for the first data block. The UE 110 may then determine (step 910-0) a first channel matrix, Z₀. The channel matrix may be determined (step 910-0) as a two-dimensional FFT of a quotient of the reception matrix and the reconstructed transmission matrix. That is, Z₀=FFT_{2D}(Y₀/X₀). On the basis of the first channel matrix, the UE 110 may estimate (step 912-0) various sensing parameters, including delay parameters and Doppler shift parameters. The UE 110 may then transmit (step 914-0), to the TRP 170, a first sensing report. The first sensing report may include some or all of the sensing parameters that have been determined (step 912-0) and may be associated with the data block index, DBo.

FIG. 9 illustrates two sensing methods arranged to occur for data blocks received in two corresponding time slots (the first time slot, the G^{th} time slot) among a plurality of sensing methods arranged to occur for data blocks received in a corresponding plurality of time slots. The plurality of time slots may include all time slots when, as illustrated in FIG. 6, sensing is to occur on the basis of all data blocks. The plurality of time slots may include a subset of the time slots when, as illustrated in FIG. 8, sensing is to occur on the basis of a subset of the data blocks.

In the G^{th} time slot, the UE 110 obtains (step 902-G−1) a G^{th} reception matrix, Y_{G-1}. Obtaining (step 902-G−1) the G^{th} reception matrix, Y_{G-1}, may be accomplished in a manner similar to the manner, described hereinbefore, of obtaining (step 902-0) the first reception matrix, Y₀. The UE 110 then decodes (step 904-G−1) the G^{th} data block, referenced with a data block index, DB(G−1). Upon determining (step 906-G−1) that the decoding has been successful, the UE 110 reconstructs (step 908-G−1) the G^{th} transmission matrix, X_{G-1}. Reconstructing (step 908-G−1) the G^{th} transmission matrix, X_{G-1}, may be accomplished in a manner similar to the manner, described hereinbefore, of reconstructing (step 908-0) the first transmission matrix, X₀. The UE 110 may then determine (step 910-G−1) a G^{th} channel matrix, Z_{G-1}. The G^{th} channel matrix may be determined (step 910-G−1) as a two-dimensional FFT of a quotient of the reception matrix and the reconstructed transmission matrix. That is, Z_{G-1}=FFT_{2D}(Y_{G-1}/X_{G-1}). On the basis of the G^{th} channel matrix, the UE 110 may estimate (step 912-G−1) various sensing parameters. The UE 110 may then transmit (step 914-G−1), to the TRP 170, a G^{th} sensing report. The G^{th} sensing report may include some or all of the sensing parameters that have been determined (step 912-G−1) and may be associated with the data block index, DB(G−1).

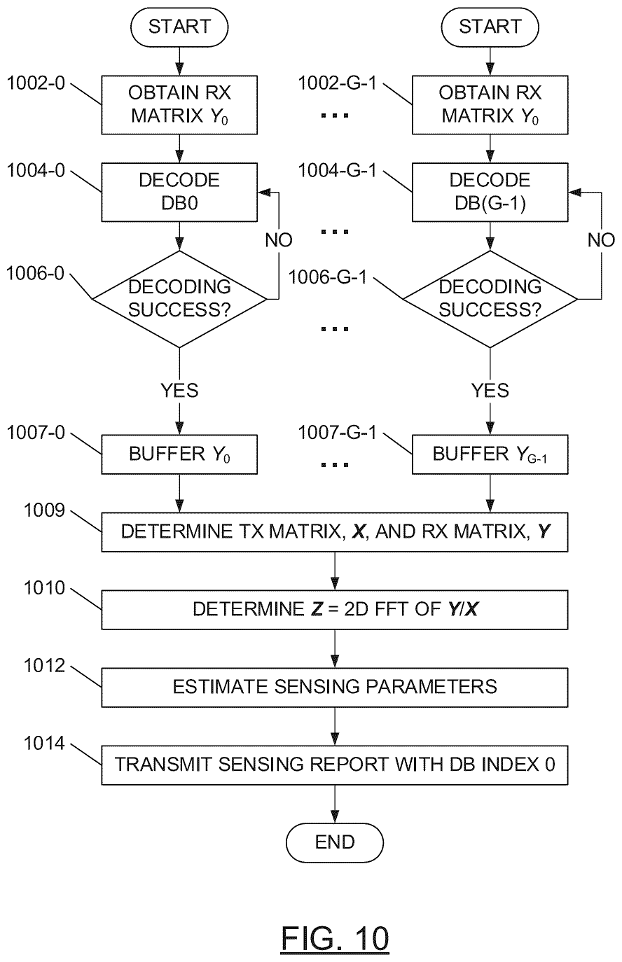

FIG. 10 illustrates example steps in a method of processing received scheduled transmissions for carrying out by a UE 110 that, in contrast to the UE 110 for which the methods of FIG. 9 are intended, has buffering capability and multi-BWP processing capability. Due to the presence of buffering capability and multi-BWP processing capability, the UE 110 may be configured to jointly perform sensing parameter estimation on a plurality of decoded data blocks. The method of FIG. 10 is presented as a plurality of methods performed on a plurality of example data blocks. However, in contrast to the plurality of methods illustrated in FIG. 9, the plurality of methods illustrated in FIG. 10 converge for the final steps. The example data blocks are referenced with data block indices DBo and DB(G−1). As illustrated in FIG. 8, it may be that not all data blocks are designated for sensing.

In the first time slot, the UE 110 obtains (step 1002-0) a first reception matrix, Y₀. The UE 110 then decodes (step 1004-0) the first data block, referenced with a data block index, DBo. Upon determining (step 1006-0) that the decoding has been successful, the UE 110 buffers (step 1007-0) the first reception matrix, Y₀.

In the G^{th} time slot, the UE 110 obtains (step 1002-G−1) a G^{th} reception matrix, Y_{G-1}. The UE 110 then decodes (step 1004-G−1) the G^{th} data block, referenced with a data block index, DB(G−1). Upon determining (step 1006-G−1) that the decoding has been successful, the UE 110 buffers (step 1007-G−1) the G^{th} reception matrix, Y_{G-1}.

The UE 110 may next combine all transmission matrices, [X₀, . . . , X_{G-1}], to determine (step 1009) an overall transmission matrix, X. The UE 110 may also combine all reception matrices, [Y₀, . . . , Y_{G-1}], to determine (step 1009) an overall reception matrix, Y. Each of the reception matrices, [Y₀, . . . , Y_{G-1}], may be obtained in a manner similar to the manner, described hereinbefore, of obtaining (step 902-0) the first reception matrix, Y₀. Each of the transmission matrices, [X₀, . . . , X_{G-1}], may be reconstructed in a manner similar to the manner, described hereinbefore, of reconstructing (step 908-0) the first transmission matrix, X₀. The process of combining the individual transmission and reception matrices X_{g} and Y_{g}, g=0, . . . , G−1, may involve inserting 0 matrices for the time/frequency resources for which no data block is transmitted over (“empty regions”). In this case, the size of the 0 matrices may be obtained based on a number of OFDM symbols and a number of subcarriers of the corresponding empty region.

The UE 110 may then determine (step 1010) an overall channel matrix, Z. The overall channel matrix, Z, may be determined (step 1010) as a two-dimensional FFT of a quotient of the overall reception matrix, Y, and the overall transmission matrix, X. That is, Z=FFT_{2D}(Y/X). On the basis of the overall channel matrix, Z, the UE 110 may estimate (step 1012) various sensing parameters. The UE 110 may then transmit (step 1014), to the TRP 170, an overall sensing report. The overall sensing report may include some or all of the sensing parameters that have been determined (step 1012).

Aspects of the present application relate to the TRP 170 scheduling and signaling, to the UE 110 through DCI, a configuration for a sensing feedback report channel. Because sensing detection is associated with data decoding, there are many options for the content of the sensing feedback report channel.

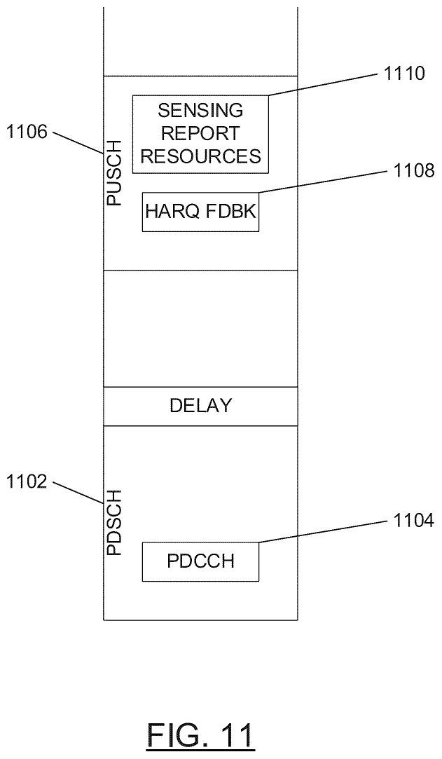

In a first option, the TRP 170 may, as illustrated in FIG. 11, transmit a PDCCH 1104 that includes an instruction for the UE 110. Notably, a data block (not shown) that is to be used for sensing detection at the UE 110 may be carried by the PDSCH 1102. The instruction may indicate, to the UE 110, to bundle a sensing feedback report channel with a future transmission as part of the HARQ protocol. In a case wherein a sensing report is associated with each individual HARQ process, the sensing feedback report channel may be defined separately for each HARQ process. In this case, the instructions include an assignment, by the TRP 170, of sensing report resources 1110 (in the time domain and the frequency domain) for each sensing feedback report channel. The instructions, in general, and the sensing report resources, in particular, may be communicated, to the UE 110, in a new field of the DCI in the PDCCH 1104. Subsequently, after a delay associated with decoding and sensing detection, the UE 110 may transmit a PUSCH 1106, in which the UE 110 includes HARQ feedback 1108. In the same PUSCH 1106, the UE 110 may use sensing report resources 1110, assigned by the TRP 170, to transmit the sensing feedback report.

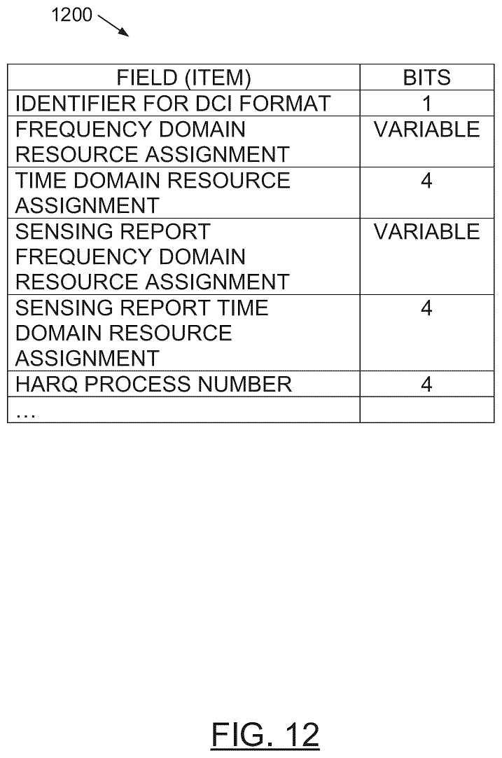

In an example table 1200 in FIG. 12, a quantity of bits is associated with each field in a plurality of fields of the DCI in the PDCCH 1104. The DCI is known to include a specification of UL resources in the frequency domain and/or the time domain for the HARQ feedback 1108 for a certain HARQ process number. The example table 1200 in FIG. 12 differs from conventional specification of UL resources in that the example table 1200 in FIG. 12 includes specification of the sensing report resources 1110 in the frequency domain and/or the time domain for the transmission of the sensing feedback report channel. Multiple sensing report resources 1110 per HARQ process may be defined for a case wherein decoding errors occur for some data blocks.

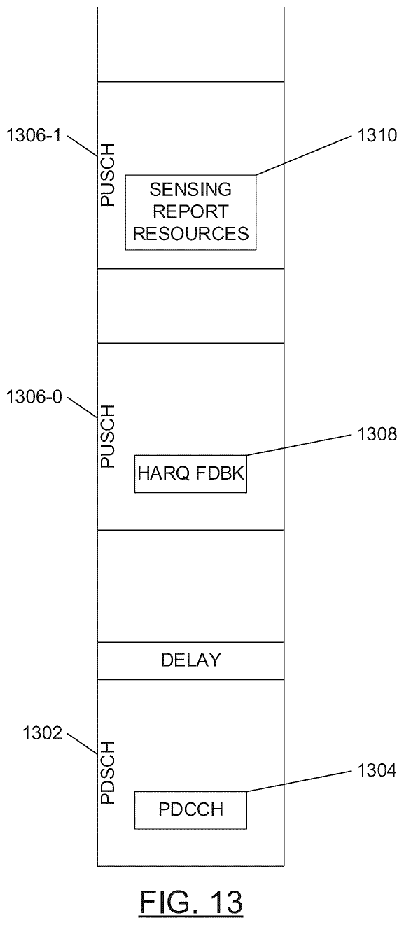

In a second option, the TRP 170 may, as illustrated in FIG. 13, transmit a PDCCH 1304 that includes an instruction for the UE 110. Notably, a data block (not shown) that is to be used for sensing detection at the UE 110 may be carried by the PDSCH 1302. The instruction may indicate, to the UE 110, to transmit a sensing feedback report channel separate from a future transmission as part of the HARQ protocol. In a case wherein a sensing report is associated with each individual HARQ process, the sensing feedback report channel may be defined separately for each HARQ process. In contrast, in the case illustrated in FIG. 13, the instructions include an assignment, by the TRP 170, of sensing report resources 1310 (in the time domain and the frequency domain) for the sensing feedback report channel. The instructions, in general, and the sensing report resources, in particular, may be communicated, to the UE 110, in a new field of the DCI in the PDCCH 1304. Subsequently, after a delay associated with decoding and sensing detection, the UE 110 may transmit a first PUSCH 1306-0, in which the UE 110 includes HARQ feedback 1308. In a second PUSCH 1306-1, the UE 110 may use the sensing report resources 1310, assigned by the TRP 170, to transmit the sensing feedback report channel. Notably, in FIG. 13, the HARQ feedback 1308 temporally precedes the sensing report in the sensing report resources 1310. However, this need not be the case. Indeed, it is contemplated that the sensing report in the sensing report resources 1310 may temporally precede the HARQ feedback 1308.

The second option may be considered to be mainly applicable to a scenario wherein the UE 110 transmits a single, aggregate sensing report for all decoded data blocks in a given sensing region.

In the second option, the sensing feedback report channel may use sensing report resources that are defined using new fields in UL DCI (format 0_0 or 0_1). That is, the UE 110 may include the sensing feedback report channel in the second PUSCH 1306-1.

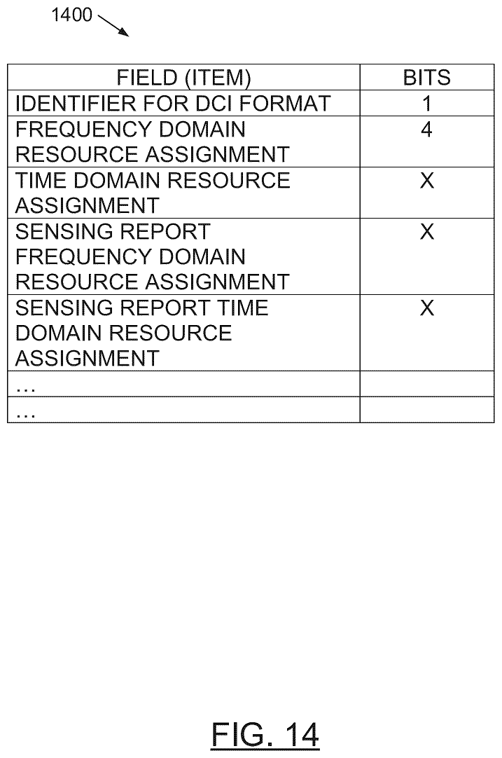

In an example table 1400 in FIG. 14, a quantity of bits is associated with each field in a plurality of fields of the DCI in the PDCCH 1304. The DCI is known to include a specification of UL resources in the frequency domain and/or the time domain for the HARQ feedback 1308 for a certain HARQ process number. The example table 1400 in FIG. 14 differs from conventional specification of UL resources in that the example table 1400 in FIG. 14 includes specification of the sensing report resources 1310 in the frequency domain and/or the time domain for the transmission of the sensing feedback report channel. In contrast to the example table 1200 in FIG. 12, the in the example table 1400 in FIG. 14, the specification of UL sensing report resources is not tied to a specific HARQ process.

In cases where the UE 110 experiences a decoding error (NACK) for some data blocks, it is understood that sensing may not be carried out. Responsive to experiencing a decoding error (NACK), the UE 110 may act in a manner that has been defined in a configuration. The configuration may be communicated, to the UE, by SensingReportConfiguration using RRC signaling. The configuration may include an indication related to whether the UE 110 is to bundle the sensing feedback report with HARQ process or how to behave in case of decoding errors.

In an example configuration (corresponding to sensingNACKreportconfiguration0), the UE 110 may ignore an unsuccessful decoding of a data block in the sensing feedback report.

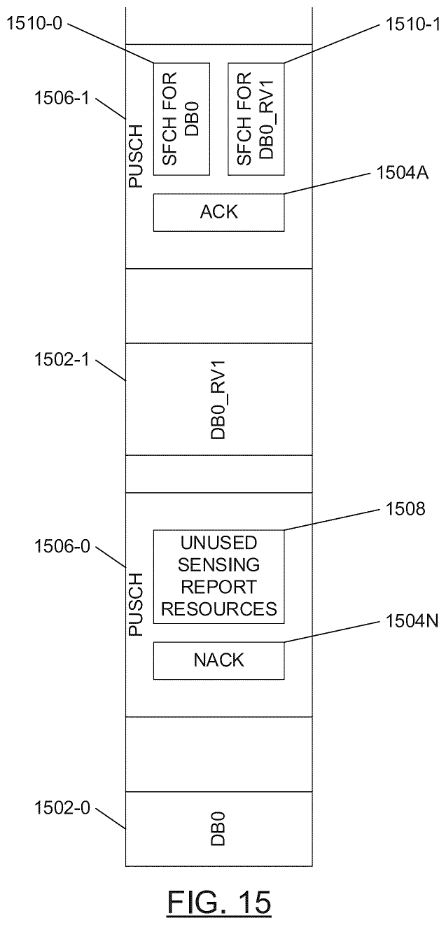

In another example configuration (corresponding to sensingNACKreportconfiguration1) and illustrated in FIG. 15, the UE 110 may transmit a sensing feedback report corresponding to NACK data blocks, after the NACK data blocks are eventually decoded successfully after retransmission(s), in a manner that is separate from a sensing feedback report corresponding to ACK data blocks.

FIG. 15 illustrates that a UE 110 may receive an initial transmission 1502-0 of a first data block, DBo. After failing to properly decode the initial transmission 1502-0 the first data block, DBo, the UE 110 may transmit a first PUSCH 1506-0. The first PUSCH 1506-0 may include a NACK 1504N to indicate, to the TRP 170, that the first data block, DB0, has not been properly decoded. Although the first PUSCH 1506-0 includes sensing report resources 1508, the UE 110 allows the sensing report resources 1508 to go unused since the UE 110 does not have any sensing estimation results to report. The UE 110 may subsequently receive a retransmission 1502-1 of the first data block, DB0_RV1. After properly decoding the first data block, DB0, with the help of the retransmission 1502-1 of the first data block, DB0_RV1, the UE 110 may transmit a second PUSCH 1506-1. The second PUSCH 1506-1 may include an ACK 1504A to indicate, to the TRP 170, that DB0 has been properly decoded as well as the retransmission 1502-1 of the first data block, DB0_RV1. The second PUSCH 1506-1 may also include two sensing feedback channels: a first sensing feedback channel 1510-0 for the initial transmission 1502-0 of the first data block, DB0; and a second feedback channel 1510-1 for the retransmission 1502-1 of the first data block, DB0_RV1.

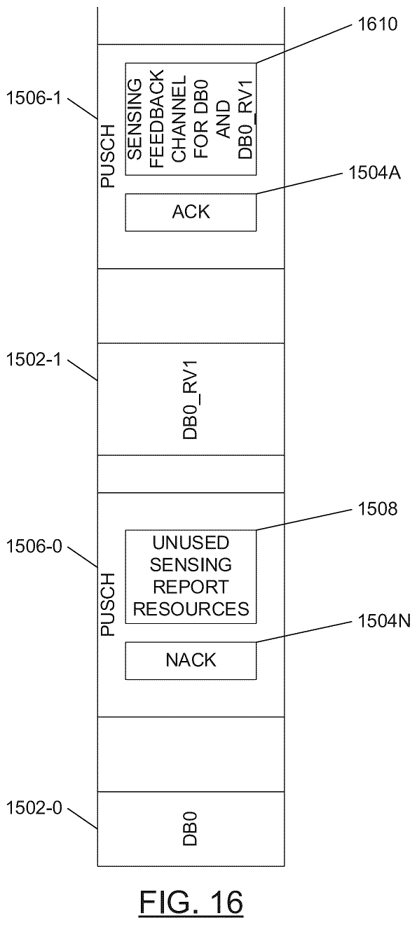

In a further example configuration (corresponding to sensingNACKreportconfiguration2) and illustrated in FIG. 16, the UE 110 may transmit a sensing feedback report all together in one report opportunity.

FIG. 16 illustrates that a UE 110 may receive an initial transmission 1502-0 of a first data block, DB0. After failing to properly decode the initial transmission 1502-0 the first data block, DB0, the UE 110 may transmit a first PUSCH 1506-0. The first PUSCH 1506-0 may include a NACK 1504N to indicate, to the TRP 170, that the first data block, DB0, has not been properly decoded. Although the first PUSCH 1506-0 includes sensing report resources 1508, the UE 110 allows the sensing report resources 1508 to go unused since the UE 110 does not have any sensing estimation results to report. The UE 110 may subsequently receive a retransmission 1502-1 of the first data block, DB0_RV1. After properly decoding the first data block, DB0, with the help of the retransmission 1502-1 of the first data block, DB0_RV1, the UE 110 may transmit a second PUSCH 1506-1. The second PUSCH 1506-1 may include an ACK 1504A to indicate, to the TRP 170, that DB0 has been properly decoded as well as the retransmission 1502-1 of the first data block, DB0_RV1. The second PUSCH 1506-1 may also include an aggregate sensing feedback channel 1610 for the initial transmission 1502-0 of the first data block, DB0, and for the retransmission 1502-1 of the first data block, DB0_RV1.

Aspects of the present application relate to a scenario wherein a UE 110 receives, from a TRP 170, a plurality of PDSCH transmissions associated with a corresponding plurality of spatial layers.

It is known that two signals received after transmission from the same antenna port at a given device are likely to experience the same radio channel. In contrast, two signals received after transmission from two different antenna ports at the given device are likely to experience distinct radio conditions. Notably, there are some cases wherein two signals received after transmission from two different antenna ports experience radio channels having common properties. In such cases, the antenna ports may be said to be Quasi-Co-Located (QCL). Indeed, an effort may be put in to making it more likely that two or more PDSCH transmissions are Quasi-Co-Located. The effort may be called a QCL configuration.

In the absence of QCL configurations for the plurality of PDSCH transmissions, the UE 110 may treat each received PDSCH transmission individually. The UE 110 may treat each received PDSCH transmission in a manner described hereinbefore.

However, in the presence of QCL configurations for, say, two PDSCH transmissions transmitted, at the TRP 170, from the same antenna port or on the same beam, the UE 110 may be understood to have options for processing the PDSCH transmissions for sensing purposes and for the purposes of transmitting a sensing feedback report.

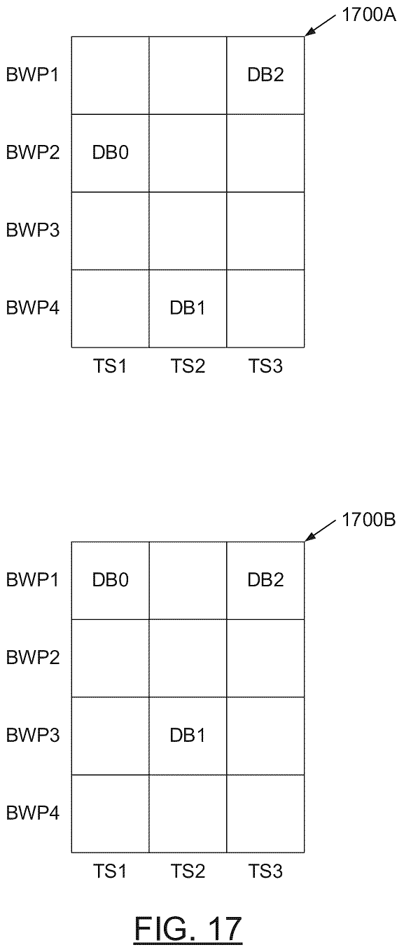

Consider a first communication scheduling region 1700A for a first set of PDSCH transmissions and a second communication scheduling region 1700B for a second set of PDSCH transmissions, as illustrated in FIG. 17. In view of FIG. 17, it is notable that the resources (BWP1, TS3) scheduled for one data block (DB2) in the first communication scheduling region 1700A are the same as the resources (BWP1, TS3) scheduled for the same data block (DB2) in the second communication scheduling region 1700B. These may be called overlapping resources.

In a first option, the UE 110 may process received QCLed PDSCH transmissions and transmit a single sensing feedback report for all received QCLed PDSCH transmissions. In the first option, the sensing feedback report is unlikely to be associated with a particular HARQ process.

In a second option, the UE 110 may process received QCLed PDSCH transmissions and transmit a single sensing feedback report corresponding to each PDSCH transmission. In the second option, when the UE 110 is scheduled over overlapping resources, it is possible that one data block (DB2, in the first communication scheduling region 1700A, see FIG. 17) from a first PDSCH transmission is decoded successfully but another data block (DB2, in the second communication scheduling region 1700B, see FIG. 17) from a second PDSCH transmission is not decoded successfully. In this case, the UE 110 may report sensing based on processing the data block DB2 from the first PDSCH transmission. Alternatively, the UE 110 may recognize that the data block from the first PDSCH transmission has been decoded successfully despite interference from data in the second PDSCH transmission. Accordingly, the UE 110 may delay the processing of, for sensing purposes, the data block from the first PDSCH transmission. It follows that the UE 110 may also delay the transmission of the sensing feedback report related to the data block from the first PDSCH transmission. The UE 110 may wait for retransmission of the data block DB2 from the second PDSCH transmission. Upon successfully decoding the data block DB2 from the second PDSCH transmission, the UE 110 may process, for sensing purposes, the data block from the first PDSCH transmission. The processing, by the UE 110, of the data block from the first PDSCH transmission may involve interference removal. That is, the information gained by successfully decoding the data block DB2 from the second PDSCH transmission, may be shown to allow the UE 110 to remove, from the data block from the first PDSCH transmission, interference from the data in the data block DB2 from the second PDSCH transmission. Similarly, information gained by successfully decoding the data block DB2 from the first PDSCH transmission, may be shown to allow the UE 110 to remove, from the data block from the second PDSCH transmission, interference from the data in the data block DB2 from the first PDSCH transmission. This process may help in obtaining higher accuracy sensing estimation corresponding to both data blocks since the receiver experiences higher effective signal to noise plus interference ratio (SINR) conditions for both data blocks, due to interference mitigation.

All of these UE behaviors can be defined as an additional Sensing ReportConfiguration parameter (through RRC signaling) to indicate the UE behavior in this scenario.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
receiving, from a device, a sensing capability report;
transmitting, to the device, a first definition for a sensing region, the first definition for the sensing region defined based on the sensing capability report;
transmitting, to the device, a second definition for a sensing feedback report channel;
transmitting, to the device, a data transmission; and
receiving, from the device over the sensing feedback report channel, a sensing report based on processing the data transmission received in the sensing region.

2. The method of claim 1, wherein the sensing capability report indicates at least one of: a buffering capability or a data transmission processing capability, and wherein the data transmission processing capability indicates at least one of:
a sensing processing delay,
a sensing bandwidth processing capability, or
a sensing time duration processing capability.

3. The method of claim 1, wherein the first definition for the sensing region is further based on a quality of sensing requirement.

4. The method of claim 1, wherein the second definition for the sensing feedback report channel is based, at least in part, on one or more of:
a length of the sensing region,
a processing latency at the device,
a type for the sensing report, or
a sensing latency requirement.

5. The method of claim 1, wherein the second definition for the sensing feedback report channel specifies merging sensing feedback with communication-related feedback or specifies a dedicated sensing feedback report channel.

6. An apparatus comprising:
a memory storing instructions; and
at least one processor caused, by executing the instructions, to cause the apparatus to:
receive, from a device, a sensing capability report;
transmit, to the device, a first definition for a sensing region, the first definition for the sensing region defined based on the sensing capability report;
transmit, to the device, a second definition for a sensing feedback report channel;
transmit, to the device, a data transmission; and
receive, from the device over the sensing feedback report channel, a sensing report based on processing the data transmission received in the sensing region.

7. The apparatus of claim 6, wherein the sensing capability report indicates at least one of:
a buffering capability or a data transmission processing capability, and wherein the data transmission processing capability indicates at least one of:
a sensing processing delay,
a sensing bandwidth processing capability, or
a sensing time duration processing capability.

8. The apparatus of claim 6, wherein the first definition for the sensing region is further based on a quality of sensing requirement.

9. The apparatus of claim 6, wherein the second definition for the sensing feedback report channel is based, at least in part, on one or more of:
a length of the sensing region,
a processing latency at the device,
a type for the sensing report, or
a sensing latency requirement.

10. The apparatus of claim 6, wherein the second definition for the sensing feedback report channel specifies merging sensing feedback with communication-related feedback or specifies a dedicated sensing feedback report channel.

11. A method comprising:
transmitting a sensing capability report to a base station;
receiving a first definition for a sensing region from the base station, the first definition for the sensing region defined based on the sensing capability report;
receiving a second definition for a sensing feedback report channel from the base station;
receiving a data transmission from the base station; and
transmitting, over the sensing feedback report channel to the base station, a sensing report based on processing the data transmission received in the sensing region.

12. The method of claim 11, wherein the sensing capability report indicates at least one of: a buffering capability or a data transmission processing capability, and wherein the data transmission processing capability indicates at least one of:
a sensing processing delay,
a sensing bandwidth processing capability, or
a sensing time duration processing capability.

13. The method of claim 11, wherein the first definition for the sensing region is further based on a quality of sensing requirement.

14. The method of claim 11, wherein the second definition for the sensing feedback report channel is based, at least in part, on one or more of:
a length of the sensing region,
a processing latency at a device,
a type for the sensing report, or
a sensing latency requirement.

15. The method of claim 11, wherein the second definition for the sensing feedback report channel specifies merging sensing feedback with communication-related feedback or specifies a dedicated sensing feedback report channel.

16. An apparatus comprising:
a memory storing instructions; and
at least one processor caused, by executing the instructions, to cause the apparatus to:
transmit a sensing capability report to a base station;
receive a first definition for a sensing region from the base station, the first definition for the sensing region defined based on the sensing capability report;
receive a second definition for a sensing feedback report channel from the base station;
receive a data transmission from the base station; and
transmit, over the sensing feedback report channel to the base station, a sensing report based on processing the data transmission received in the sensing region.

17. The apparatus of claim 16, wherein the sensing capability report indicates at least one of: a buffering capability or a data transmission processing capability, and wherein the data transmission processing capability indicates at least one of:
a sensing processing delay,
a sensing bandwidth processing capability, or
a sensing time duration processing capability.

18. The apparatus of claim 16, wherein the first definition for the sensing region is further based on a quality of sensing requirement.

19. The apparatus of claim 16, wherein the second definition for the sensing feedback report channel is based, at least in part, on one or more of:
a length of the sensing region,
a processing latency at the apparatus,
a type for the sensing report, or
a sensing latency requirement.

20. The apparatus of claim 16, wherein the second definition for the sensing feedback report channel specifies merging sensing feedback with communication-related feedback or specifies a dedicated sensing feedback report channel.
